(19) United States
(12) Patent Application Publication
(10) Pub. No.: US 2026/0296541 A1
(43) Pub. Date: Oct. 1, 2026

(54) Method for Detecting Angle in a Steering System

(71) Applicant: Conserve & Associates, Inc., Taoyuan City (TW)

(72) Inventors: Teng-Chieh Hsu, Taoyuan City (TW); Tseng-Jen Su, Hsinchu City (TW); Shih-Ming Lin, New Taipei City (TW)

(73) Assignee: Conserve & Associates, Inc., Taoyuan City (TW)

(21) Appl. No.: 19/199,428

(22) Filed: May 6, 2025

(30) Foreign Application Priority Data
Apr. 1, 2025 (TW) 114112494

(51) Int. Cl. B62D 15/02

(52) U.S. Cl. CPC B62D 15/0225

(57) ABSTRACT

A steering system angle sensing method addresses the issue of requiring a single-sided SN bipolar magnet's installation direction to be at 0° magnetic field, which involves setting up a magnetic angle sensor to detect the magnetic field angle from at least one magnet on a rotating component or driven gear, outputting an absolute angle value. After initialization, the first absolute angle is recorded as the starting angle. The current relative angle is calculated based on the relationship between the current and starting absolute angles, determining the rotation direction and number of turns. Using the relative angle, direction, and turns, the precise rotation angle and direction of the main rotating component or gear are computed. If the system starts with the component not at 0°, it retrieves stored rotation data from the last shutdown, applying offset compensation to correct the angle. This method eliminates consideration of magnet installation direction, enhancing flexibility.

### BACKGROUND OF THE INVENTION

### 1. Field of the Invention

The present invention relates to a steering system angle sensing method, and more particularly, to a steering system angle sensing method capable of converting absolute angles into relative angles and determining the rotation direction and accumulated number of turns, which enables the calculation of the final angle between 0 and 360 degrees or, based on the periodic definition in generalized trigonometric functions, extends beyond the 360-degree limit to continuously maintain the accumulated calculation of the steering angle.

### 2. Description of the Prior Art

Steering angle sensors are widely utilized in vehicle steering systems to detect the steering angle of an automobile steering wheel, enabling related systems (such as the body control module, electronic stability control system, etc.) to ascertain the steering angle of the steering wheel and execute corresponding safety control strategies.

Specifically, steering angle sensors employ single-sided

SN bipolar magnets embedded on one or more small gears. By detecting changes in the magnetic field angle during gear rotation (ranging from 0° to 360°), and based on the gear ratio between the main gear (steering column) and the small gears, the current rotation angle of the steering wheel is calculated. To ensure that the initial steering angle of the steering wheel is 0° upon activation of the steering angle sensor, it is essential that the system, after startup, provides an unbiased reading of the steering angle of the steering wheel. Consequently, during the production and assembly process of the sensor, the installation direction of the single-sided SN bipolar magnet and its coordination with the gears are critical. Not only must the installation direction of the magnet be aligned at a 0° magnetic field, but the gear installation must also ensure that the steering angle of the main gear aligns with the steering angle position of the steering wheel. This assembly process significantly increases the complexity of producing steering angle sensors and typically requires additional angle positioning tools and fixtures to ensure installation accuracy, thereby elevating production costs. To simplify this process and reduce assembly errors, manufacturers of vehicle steering systems may opt for more expensive angle sensors equipped with automatic zero calibration functions, which address the angle zero positioning issue entirely through hardware. However, the development and production costs of such sensors are also higher.

Therefore, in the context of increasingly complex automotive electronic systems, developing an economical and precise angle sensing solution has become a significant challenge in the industry.

### SUMMARY OF THE INVENTION

Accordingly, the present invention primarily provides a steering system angle sensing method that does not require special calibration or adjustment of the single-sided SN bipolar magnet's installation direction to a 0° magnetic field during production and assembly. This method ensures that, when the steering component or driven gear is in a centered state, the output angle is 0°, thereby offering an economical and precise angle sensing solution.

An embodiment of the present invention discloses a steering system angle sensing method for sensing the rotation of one or more rotating components in a steering system, wherein each of the one or more rotating components is configured with a magnet. The steering system comprises a main gear, connected to a steering shaft; one or more driven gears, respectively meshing with the main gear; one or more magnets, respectively disposed on the one or more driven gears; one or more magnetic angle sensors, respectively configured to sense the magnetic field angles generated by the one or more magnets and output one or more absolute angle values; a processing unit; and a storage unit, coupled to the processing unit, storing program code that instructs the processing unit to execute the steering system angle sensing method, enabling the sensing of the rotation of the one or more rotating components or driven gears using the one or more magnetic angle sensors, the steering system angle sensing method comprising the steps of recording one or more first sets of absolute angle values between 0 and 360 degrees output by the one or more magnetic angle sensors after completing an initialization procedure as one or more starting absolute angles; calculating one or more current relative angle values based on the relationship between the one or more current absolute angle values measured by the one or more magnetic angle sensors and the one or more starting absolute angles; determining a rotation direction of the one or more rotating components or the one or more driven gears based on the one or more current relative angle values and their respective at least one set of previous relative angle values; determining a number of turns of the one or more rotating components or the one or more driven gears based on the positional changes of the one or more current relative angle values and their respective at least one set of previous relative angle values relative to a plurality of preset quadrants; and calculating and determining an actual rotation angle, direction, and a number of turns of the main gear meshed with the one or more rotating components or the one or more driven gears based on at least one of the one or more current relative angle values, the rotation direction of the one or more rotating components or the one or more driven gears, and the number of turns of the one or more rotating components or the one or more driven gears.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the steering angle sensing system according to an embodiment of the present invention.

FIG. 2 is a schematic diagram of the steering angle sensing process according to an embodiment of the present invention.

FIG. 3 is a schematic diagram of the functional unit set according to an embodiment of the present invention.

FIG. 4 is a schematic diagram of the gear system according to an embodiment of the present invention.

### DETAILED DESCRIPTION

Certain terms are used throughout the specification and claims to refer to specific elements. Those skilled in the art will understand that hardware manufacturers may use different terms to designate the same element. The specification and claims distinguish elements based on their functional differences rather than differences in nomenclature. The terms “comprising” and “including” as used in the specification and claims are open-ended and should be interpreted as “including but not limited to.” The term “substantially” refers to an acceptable error range within which those skilled in the art can address the technical problem and substantially achieve the intended technical effect. Additionally, the term “coupled” encompasses any direct or indirect, wired or wireless connection means.

To reduce the development or production costs of steering angle sensors, magnetic angle sensors based on the tunnel magneto-resistance (TMR) effect can be employed. Such sensors output absolute angles ranging from 0° to 360° and increase or decrease the angle based on the rotation direction. When the angle completes one full turn (left or right), the absolute angle returns to 0° and continues to cycle, incrementing or decrementing according to the rotation direction. However, since TMR magnetic angle sensors only sense and output absolute angles, challenges arise with angle zero positioning during assembly and production, and they cannot determine the gear's rotation direction or number of turns. To address this, the present invention proposes a steering system angle sensing method that effectively resolves the requirement for the installation direction of the single-sided SN bipolar magnet to be at a 0° magnetic field for angle zero positioning during assembly and production. Simultaneously, the method converts absolute angles into relative angles and determines the rotation direction and number of turns to calculate the final steering angle of the steering system.

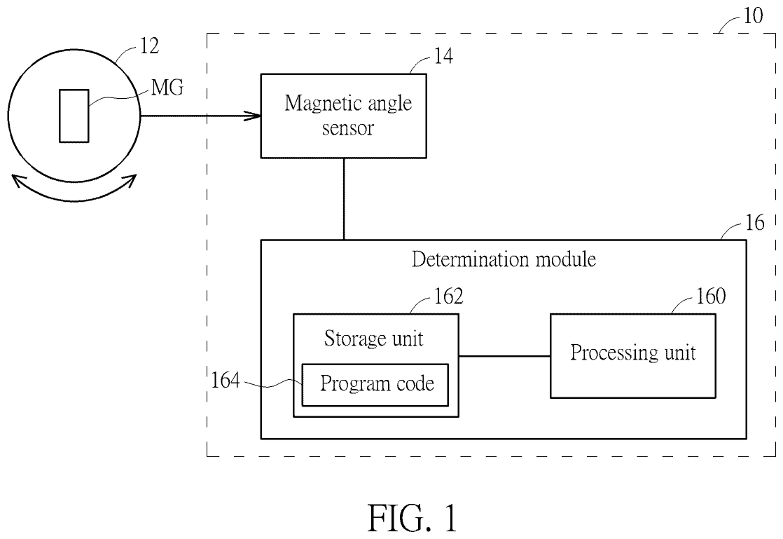

Please refer to FIG. 1, which illustrates a schematic diagram of a steering angle sensing system 10 according to an embodiment of the present invention. The steering angle sensing system 10 is configured to sense the rotation of the rotating component 12, which may be a gear or any rotatable element, with a magnet MG disposed thereon. The steering angle sensing system 10 comprises a magnetic angle sensor 14 and a determination module 16. The magnetic angle sensor 14 is preferably based on the tunnel magneto-resistance effect and is used to sense the magnetic field angle generated by the magnet MG, outputting an absolute angle value. The determination module 16 includes a processing unit 160 and a storage unit 162, which utilize the magnetic angle sensor 14 to sense the rotation of the rotating component 12, including its rotation angle, number of turns, and rotation direction. Specifically, the storage unit 162 stores program code 164, which instructs the processing unit 160 to execute the steering angle sensing process 20. The steering angle sensing process 20 converts the absolute angle value sensed by the magnetic angle sensor 14 into a relative angle value and determines parameters such as the rotation direction and rotation angle of the rotating component 12 based on both absolute and relative angle values.

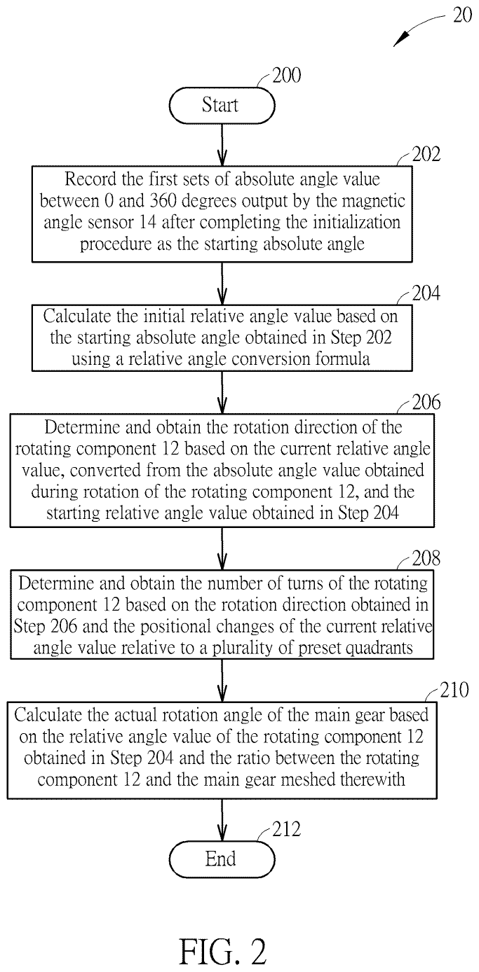

Please refer to FIG. 2, which presents a schematic diagram of the steering angle sensing process 20. The steering angle sensing process 20 includes the following steps:

Step 200: Start.

Step 202: Record the first sets of absolute angle value between 0 and 360 degrees output by the magnetic angle sensor 14 after completing the initialization procedure as the starting absolute angle.

Step 204: Calculate the initial relative angle value based on the starting absolute angle obtained in Step 202 using a relative angle conversion formula.

Step 206: Determine and obtain the rotation direction of the rotating component 12 based on the current relative angle value, converted from the absolute angle value obtained during rotation of the rotating component 12, and the starting relative angle value obtained in Step 204.

Step 208: Determine and obtain the number of turns of the rotating component 12 based on the rotation direction obtained in Step 206 and the positional changes of the current relative angle value relative to a plurality of preset quadrants.

Step 210: Calculate the actual rotation angle of the main gear based on the relative angle value of the rotating component 12 obtained in Step 204 and the ratio between the rotating component 12 and the main gear meshed therewith.

Step 212: End.

According to the steering angle sensing process 20, the determination module 16 records the first sets of absolute angle value between 0 and 360 degrees output by the magnetic angle sensor 14 after completing the initialization procedure as the starting absolute angle (Step 202), and the starting absolute angle serves as the baseline reference angle. Subsequently, in Step 204, the determination module 16 calculates the current initial relative angle value using a relative angle conversion method based on the initial absolute angle value detected in Step 202. The initial relative angle value is the primary angle parameter for calculating the rotation of the rotating component 12. Specifically, in one embodiment, if the current absolute angle value is greater than or equal to the starting absolute angle and less than or equal to 360 degrees, the steering angle sensing process 20 determines that the current relative angle value equals the current absolute angle value minus the starting absolute angle value. Conversely, if the current absolute angle value is less than the starting absolute angle value, the steering angle sensing process 20 determines that the current relative angle value equals the current absolute angle value plus 360 degrees minus the starting absolute angle value. For instance, if the first sets of absolute angle value output by the magnetic angle sensor 14 after initialization is 45°, the determination module 16 sets the starting absolute angle to 45° per the steering angle sensing process 20. If the subsequent four absolute angle values detected by the magnetic angle sensor 14 are 45°, 46°, 47°, and 48°, the determination module 16, per Step 204, determines the corresponding relative angle values as 0°, 1°, 2°, and 3°. Conversely, if the four absolute angle values are 45°, 44°, 43°, and 42°, the determination module 16 determines the corresponding relative angle values as 0°, 359°, 358°, and 357°.

Next, in Step 206, the determination module 16 determines the rotation direction of the rotating component 12 based on the currently calculated relative angle value and the previous relative angle value. For example, in one embodiment, if the current relative angle value equals the previous relative angle value, the determination module 16 may determine that the rotating component 12 is stationary at system startup or has completed one full turn from any direction, returning to the initial absolute angle. According to the definition of generalized trigonometric functions, counterclockwise (left turn) corresponds to increasing angles, and clockwise (right turn) corresponds to decreasing angles. If the current relative angle value exceeds the previous relative angle value, the determination module 16 determines that the rotating component 12 is rotating counterclockwise (left turn). Conversely, if the current relative angle value is less than the previous relative angle value, the determination module 16 determines that the rotating component 12 is rotating clockwise (right turn).

In another embodiment, the determination module 16 may apply different judgment procedures based on the previous rotation direction state. Based on the four-quadrant division of generalized trigonometric functions, the quadrants are defined as follows: the first quadrant (angle values from 0 to 90 degrees), the second quadrant (angle values from 90 to 180 degrees), the third quadrant (angle values from 180 to 270 degrees), and the fourth quadrant (angle values from 270 to 360 degrees). For example, when the previous rotation direction state is stationary, the determination module 16 first compares the current absolute angle value with the starting absolute angle value. If they are equal, the determination module 16 determines that the rotating component 12 remains stationary. However, if the current absolute angle value exceeds the starting absolute angle value and the calculated relative angle value falls between 0 and 90 degrees, the determination module 16 determines that the rotating component 12 is rotating toward the first quadrant (e.g., left). Conversely, if the current absolute angle value is less than the starting absolute angle value and the calculated relative angle value falls between 270 and 359 degrees, the determination module 16 determines that the rotating component 12 is rotating toward the fourth quadrant (e.g., right).

Conversely, when the previous rotation direction state is not stationary, the determination module 16 adopts different judgment logic. If the current absolute angle value equals the starting absolute angle value, the determination module 16 determines that the rotating component 12 has returned to the starting point, i.e., the initial absolute angle. Otherwise, the determination module 16 determines the current rotation direction based on the previous rotation direction. Further, as the rotating component 12 continues to rotate, the determination module 16 compares the current relative angle value with the previous relative angle value to determine if the rotation direction has changed. Specifically, if the previous rotation direction state is a left turn and the current relative angle value equals the previous relative angle value, it indicates that the rotation angle of the rotating component 12 has returned to the starting position at startup (i.e., relative angle of 0), suggesting that the rotating component 12 may have completed one full left turn or reversed during the left turn. The determination module 16 then records the current rotation direction state as a basis for the next judgment. Similarly, if the previous rotation direction state is a right turn and the current relative angle value equals the previous relative angle value, the determination module 16 determines that the rotating component 12 may have completed one full right turn or reversed during the right turn, recording the current rotation direction state for subsequent judgment.

This approach considers the previous rotation state and applies different judgment criteria based on varying conditions, enabling a more accurate reflection of the actual motion state of the rotating component 12, particularly during transitions between stationary and moving states, thus providing precise motion state information.

Subsequently, in Step 208, the determination module 16 determines the number of turns of the rotating component 12 based on the positional changes of the current relative angle value and the previous relative angle value relative to a plurality of preset quadrants. In an embodiment, the preset quadrants are defined based on the converted relative angle values, including the first quadrant (relative angle values from 0 to 90 degrees), the second quadrant (relative angle values from 90 to 180 degrees), the third quadrant (relative angle values from 180 to 270 degrees), and the fourth quadrant (relative angle values from 270 to 360 degrees). Thus, the determination module 16 employs two quadrant definition systems to track the rotation of the rotating component 12: the absolute quadrant, based on the absolute angle values directly output by the TMR magnetic angle sensor 14, and the relative quadrant, based on the converted relative angle values. Both systems adhere to the four-quadrant division of generalized trigonometric functions, with the center of the rotating component 12 as the origin, extending left, right, up, and down to form four regions. In a preferred embodiment, the determination module 16 continuously monitors changes in the relative angle values across these preset quadrants, accurately calculating the number of turns of the rotating component 12. This method ensures precise tracking of rotation and adapts to various installation conditions, delivering reliable angle sensing results. Additionally, in another embodiment, the number of turns includes left turns and right turns, and when the number of left turns equals the number of right turns, the determination module 16 resets both counts to zero.

In short, compared to other sensing methods, the embodiment of the present invention uses a relative quadrant approach to determine the number of turns, effectively addressing misjudgments caused by the rotating component 12 reversing during rotation. Moreover, the determination module 16 tracks the motion path of the rotating component 12 based on the quadrant definitions of generalized trigonometric functions. As the rotating component 12 performs left or right turn movements, its angle position sequentially traverses the four relative quadrants. The determination module 16 continuously tracks and records the current quadrant position of the rotating component 12, using this data as motion path parameters.

Specifically, the determination module 16 first determines and selects whether to execute left-turn or right-turn processing functions based on the current rotation direction and the comparison between the current relative/absolute angle and the previous relative/absolute angle. It uses the absolute and relative angle values to determine the quadrant position of the current angle, so as to update the quadrant state in real-time. Concurrently, the determination module 16 records the quadrants traversed in the motion path parameters. Notably, when processing right-turn rotation, the determination module 16 subtracts 360 degrees from the relative angle value obtained and converted from the magnetic angle sensor 14, placing it within the range of −1 to −359 degrees. This approach aligns with the positive and negative angle definitions in generalized trigonometric functions: counterclockwise (left turn) is positive, and clockwise (right turn) is negative.

When the determination module 16 detects that the motion path parameters match those of a complete turn—indicating that the rotating component 12 has fully traversed all four quadrants—the system decides whether to increment the number of left turns or right turns based on the rotation direction. Notably, when both the numbers of left turns and right turns are non-zero and equal, it signifies that the rotating component 12 has returned to the relative zero-degree angle position at initial startup, indicating that the rotating component 12 is fully centered without any angle offset.

This relative quadrant-based method for calculating the number of turns not only accurately tracks the rotation of the rotating component 12 but also correctly handles reverse motion, providing a reliable and precise steering angle monitoring solution.

Finally, in Step 210, the determination module 16 calculates the actual rotation angle of the main gear and determines its actual rotation direction and number of turns based on the relative angle value, rotation direction, and number of turns of the rotating component 12, combined with the gear ratio between the rotating component 12 and the main gear meshed therewith. This comprehensive rotation information derived from the rotating component 12 enables a more complete provision of the steering system's motion state, including its precise rotation angle, direction, and completed number of turns.

It is noteworthy that the steering angle sensing process 20 in the embodiment includes a mechanism to correct and restore the angle when the system starts with the rotating component 12 in a non-centered state (initial relative angle not at 0°) from the user's perspective, yet the initial relative angle calculated in Step 204 is 0°. Specifically, upon system startup, the determination module 16 retrieves the initial absolute angle and initial relative angle—stored in a non-volatile storage device representing a centered state with an angle of 0°—and compares them with the first set of initial absolute angle values output by the magnetic angle sensor 14 after initialization and the converted initial relative angles. The determination module 16 then calculates an angle offset value for compensation to correct the rotation angle of the rotating component 12, enhancing sensing accuracy.

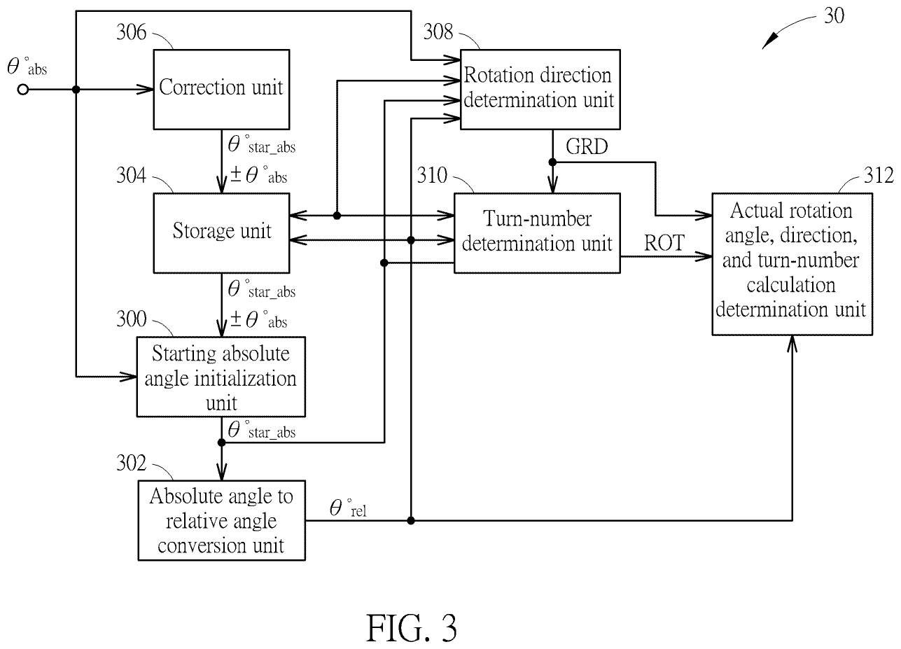

It should be noted that the steering angle sensing process 20 exemplifies the primary concept of the present invention, and those skilled in the art may make various modifications accordingly, without limitation. For instance, when implementing the steering angle sensing process 20 in software, each step or its derivatives may be realized through different functional units, each considered a program set, thread, or function. Necessary auxiliary units for realizing the steering angle sensing process 20 may be appropriately added, as would be well understood by those skilled in the art. Please refer to FIG. 3, which depicts a schematic diagram of a functional unit set 30 according to an embodiment of the present invention. The functional unit set 30 corresponds to the thread of the program code 164 to implement the steering angle sensing process 20. The functional unit set 30 comprises a starting absolute angle initialization unit 300, an absolute angle to relative angle conversion unit 302, a storage unit 304, a correction unit 306, a rotation direction determination unit 308, a turn-number determination unit 310, and an actual rotation angle, direction, and turn-number calculation determination unit 312. The storage unit 304 stores data required to execute the steering angle sensing process 20. Additionally, θ°_{abs} denotes the absolute angle value measured by the magnetic angle sensor 14, θ°_{star_abs} denotes the starting absolute angle, θ°ᵣₑₗ denotes the relative angle value, GRD denotes the rotation direction, and ROT denotes the number of turns. Specifically, the starting absolute angle initialization unit 300 executes Step 202 to record the first set of absolute angle value θ°_{abs} output by the magnetic angle sensor 14 after initialization as the starting absolute angle θ°_{star_abs}. The absolute angle to relative angle conversion unit 302 executes Step 204 to calculate the relative angle value θ°ᵣₑₗ based on the relationship between the current absolute angle value θ°_{abs} of the magnetic angle sensor 14 and the starting absolute angle value θ°_{star_abs}, storing the relative angle value θ°ᵣₑₗ in the storage unit 304. The rotation direction determination unit 308 executes Step 206 to determine the rotation direction GRD of the rotating component 12 based on the angle comparison between the current relative angle value θ°ᵣₑₗ and the previous relative angle value θ°ᵣₑₗ stored in the storage unit 304, storing the determined rotation direction GRD in the storage unit 304. The turn-number determination unit 310 executes Step 208 to determine the number of turns ROT of the rotating component 12 based on the positional changes of the current relative angle value θ°ᵣₑₗ and the previous relative angle value θ°ᵣₑₗ stored in the storage unit 304 relative to a plurality of preset quadrants. The actual rotation angle, direction, and turn-number calculation determination unit 312 executes Step 210 to determine and calculate the actual rotation state (angle, direction, number of turns) of the main gear meshed with the rotating component 12 based on the relative angle value θ°ᵣₑₗ, rotation direction GRD, and number of turns ROT. Additionally, the correction unit 306 stores the starting absolute angle value θ°_{star_abs} output by the magnetic angle sensor 14 after completing the initialization correction procedure and the converted relative angle value θ°ᵣₑₗ in the storage unit 304 when the main gear meshed with the rotating component 12 is centered and at 0°from the user's perspective. Upon the next system startup, the correction unit 306 retrieves the correction angle value from the storage unit 304 and the absolute angle sensed by the magnetic angle sensor 14, providing them to the starting absolute angle initialization unit 300 to determine and compensate for the rotation angle when the rotating component 12 is not centered (initial relative angle of 0°) from the user's perspective, thereby improving sensing accuracy.

The functional unit set 30 represents a feasible architecture for implementing the steering angle sensing process 20, and its detailed operation or derivatives may refer to the foregoing description of the steering angle sensing process 20 and are not repeated here. Furthermore, in the functional unit set 30, the connections between units may represent operations such as data transfer or function calls, not limited to signal connections, as would be familiar to those skilled in the art.

Regarding hardware implementation, the processing unit 160 of the determination module 16 may be a microprocessor, digital signal processor (DSP), or microcontroller, while the storage unit 162 may comprise read-only memory (ROM), random access memory (RAM), flash memory, or other memory devices. The program code 164 is stored in the storage unit 162, and upon system startup, the processing unit 160 reads and executes the program code 164 to realize the functions of the steering angle sensing process 20. In another embodiment, computationally intensive or time-critical functions (e.g., angle calculation, direction determination) may be implemented via hardware circuits, while more complex logical judgments are handled through software. This hybrid approach balances performance and flexibility, ensuring real-time operation and scalability. Regardless of the implementation, the determination module 16 must accurately acquire signals or data from the magnetic angle sensor 14, such as through standard communication protocols like Serial Communication Interface (SCI), Serial Peripheral Interface (SPI), or Inter-Integrated Circuit (I2C).

Moreover, as previously mentioned, the rotating component 12 may be any rotatable element. The steering angle sensing system 10 of the present invention senses the magnetic field angle generated by the magnet MG via the magnetic angle sensor 14, converting the obtained absolute angle value into a relative angle value to determine the rotation direction and number of turns of the rotating component 12. Thus, the present invention not only resolves misjudgment issues in traditional sensing methods during reverse motion but also provides enhanced rotation state monitoring capabilities. Notably, the steering angle sensing system 10 is applicable not only to sensing the steering angle of a single rotating component 12 but also, with appropriate adjustments, to gear systems with multiple driven gears to calculate the steering angle of the main gear. In such scenarios, the system must account for gear transmission ratios to accurately compute the main gear's actual rotation.

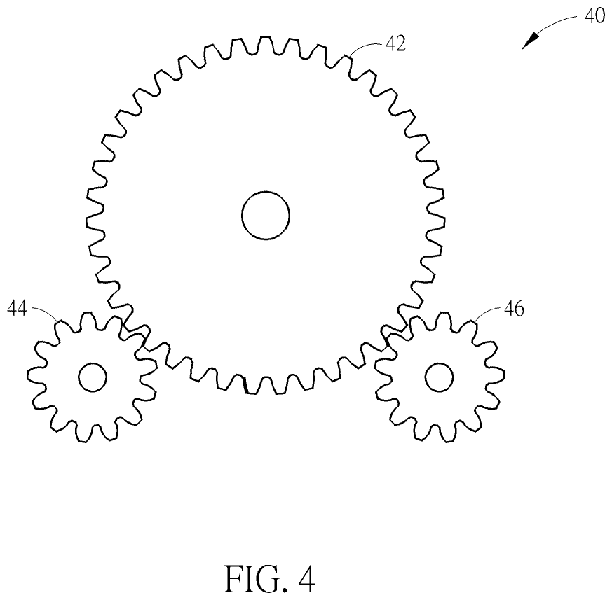

For example, please refer to FIG. 4, which illustrates a schematic diagram of a gear system 40 according to an embodiment of the present invention. The gear system 40 forms part of the steering system, comprising a main gear 42 and driven gears 44 and 46. The center of the main gear 42 is connected to or linked with a steering shaft, which is further connected to or linked with a steering wheel or other steering device, allowing the main gear 42 to rotate with the steering wheel or device. The driven gears 44 and 46 mesh with the main gear 42, each having fewer teeth than the main gear 42. Thus, when the steering wheel rotates, the main gear 42 rotates accordingly, driving the driven gears 44 and 46 to rotate in tandem.

In this embodiment, the driven gears 44 and 46 are equipped with magnets and configured with respective steering angle sensing systems (e.g., the steering angle sensing system 10 in FIG. 1). An operation module then integrates the steering angle judgment results of the driven gears 44 and 46. In another embodiment, the driven gears 44 and 46 may share or partially share the determination module of the steering angle sensing system (e.g., the determination module 16 in FIG. 1). Regardless of the implementation, the steering angle sensing system applicable to the gear system 40 detects the rotation of the driven gears 44 and 46, executing the steering angle sensing process 20 to calculate their respective relative angle values, rotation directions, and number of turns. Subsequently, the steering angle sensing system converts the steering angles of the driven gears 44 and 46 into the steering angle of the main gear 42 based on the gear ratio between the driven gears 44, 46 and the main gear 42. For example, if the main gear 42 has 60 teeth and the driven gears 44, 46 have 20 teeth, the gear ratio is 3:1, meaning that three turns of the driven gears 44, 46 correspond to one turn of the main gear 42. In this case, the steering angle sensing system divides the relative angle values of the driven gears 44, 46 by 3 to obtain the actual rotation angle of the main gear 42. Similarly, the number of turns of the driven gears 44, 46 is divided by 3 to determine the actual number of turns of the main gear 42.

Furthermore, in the gear system 40, with two driven gears 44 and 46, their steering angle results may be summed and averaged to reduce errors in an embodiment. In another embodiment, one of the driven gears 44 and 46 may serve as a redundant design, where the steering angle sensing system determines the steering angle of the main gear 42 based solely on one driven gear's result, using the other for verification or fault backup. Additionally, while the driven gears 44 and 46 in the gear system 40 have the same number of teeth, this is not restrictive. The present invention may employ multiple driven gears with different tooth counts to determine the main gear's steering angle, provided conversions are made according to the gear ratio, as derivable by those skilled in the art from the foregoing. Moreover, beyond using two driven gears 44 and 46, a single driven gear or more than three may be used, with such variations readily derivable by those skilled in the art based on the above description, and thus not elaborated here.

In brief, by cross-comparing data from one or more driven gears, the steering angle sensing system of the embodiment of the present invention accurately calculates the steering angle of the main gear. This redundant design enhances system reliability and ensures continued operation if a driven gear's sensor fails. It also offers greater configuration flexibility, freeing the sensor installation from being limited to the main gear, which is particularly advantageous in space-constrained scenarios or when installing sensors on the main gear is impractical.

For instance, the steering angle sensing system 10 of the present invention may also be applied to a vehicle's steering wheel angle sensing system. In this context, the system must accurately sense the steering wheel's steering angle while considering the mechanical linkage between the steering wheel and the steering mechanism to provide precise steering information to the vehicle's electronic control system. Using the present invention, magnetic angle sensors are installed in the gear set of the steering mechanism. Given that a steering wheel typically allows multiple turns (e.g., three to four turns from far left to far right), the multi-turn counting capability of the steering angle sensing process 20 is critical. The system continuously tracks and accumulates the steering angle, number of turns, and rotation direction of the steering wheel, ensuring accurate reflection of its position. Furthermore, as the steering wheel system interacts closely with other vehicle electronic control units (e.g., electronic stability system ESC, anti-lock braking system ABS), the steering angle sensing process 20 must provide real-time, accurate steering angle data. In practice, the system converts the sensed steering angle into a standard format, transmitting it via the vehicle's communication network (e.g., CAN bus) to relevant control units.

Notably, when a vehicle starts, the steering wheel's initial position may not be centered. Here, the angle correction function of the steering angle sensing process 20 compensates by automatically setting the current position as the relative zero-degree reference point upon each startup, tracking relative displacement during rotation. This ensures accurate steering angle information even if the steering wheel is off-center.

Applying the present invention to steering wheel angle sensing provides precise steering angle data and supports advanced active safety systems and driving assistance functions in modern vehicles, laying a vital foundation for driving safety.

From the foregoing, the steering angle sensing system and process of the present invention sense the magnetic field angle generated by the magnet via the magnetic angle sensor, converting the absolute angle value into a relative angle value to determine the rotation direction and calculate the number of turns of the rotating component. Thus, the present invention resolves misjudgments in traditional sensing methods during reverse motion and enhances rotation state monitoring accuracy. Additionally, the system employs a relative quadrant judgment mechanism, dividing rotation into four quadrants and tracking angle changes therein to precisely calculate the number of turns, making it ideal for multi-turn counting applications like steering wheel angle sensing. The angle correction function further compensates for offsets due to installation variations, significantly improving practicality and reliability.

In practical applications, the steering angle sensing system and process offer excellent adaptability and scalability, accurately sensing rotation in systems with single or multiple driven gears, such as vehicle steering angle monitoring. This broad applicability makes the present invention highly suitable for modern industrial automation and vehicle electronic control systems.

In summary, through magnetic sensing technology and computational methods, the present invention achieves a precise, reliable, and practically valuable rotation angle sensing system, applicable to fields such as industrial automation and vehicle control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A steering system angle sensing method for sensing the rotation of one or more rotating components in a steering system, wherein each of the one or more rotating components is configured with a magnet, and the steering system comprises:
a main gear, connected to a steering shaft;
one or more driven gears, respectively meshing with the main gear;
one or more magnets, respectively disposed on the one or more driven gears;
one or more magnetic angle sensors, respectively configured to sense the magnetic field angles generated by the one or more magnets and output one or more absolute angle values;
a processing unit; and
a storage unit, coupled to the processing unit, storing program code that instructs the processing unit to execute the steering system angle sensing method, enabling the sensing of the rotation of the one or more rotating components or driven gears using the one or more magnetic angle sensors, the steering system angle sensing method comprising the steps of:
recording one or more first sets of absolute angle values between 0 and 360 degrees output by the one or more magnetic angle sensors after completing an initialization procedure as one or more starting absolute angles;
calculating one or more current relative angle values based on the relationship between the one or more current absolute angle values measured by the one or more magnetic angle sensors and the one or more starting absolute angles;
determining a rotation direction of the one or more rotating components or the one or more driven gears based on the one or more current relative angle values and their respective at least one set of previous relative angle values;
determining a number of turns of the one or more rotating components or the one or more driven gears based on the positional changes of the one or more current relative angle values and their respective at least one set of previous relative angle values relative to a plurality of preset quadrants; and
calculating and determining an actual rotation angle, direction, and a number of turns of the main gear meshed with the one or more rotating components or the one or more driven gears based on at least one of the one or more current relative angle values, the rotation direction of the one or more rotating components or the one or more driven gears, and the number of turns of the one or more rotating components or the one or more driven gears.

2. The steering system angle sensing method according to claim 1, wherein the step of calculating the one or more current relative angle values based on the relationship between the one or more current absolute angle values measured by the one or more magnetic angle sensors and the one or more starting absolute angles comprises:
if the one or more current absolute angle values are greater than or equal to the one or more starting absolute angles and less than or equal to 360 degrees, determining that the one or more current relative angle values equal the one or more current absolute angle values minus the one or more starting absolute angles; and
if the one or more current absolute angle values are less than the one or more starting absolute angles, determining that the one or more current relative angle values equal the one or more current absolute angle values plus 360 degrees minus the one or more starting absolute angles.

3. The steering system angle sensing method according to claim 1, wherein the step of determining the rotation direction of the one or more rotating components or the one or more driven gears based on the one or more current relative angle values and their respective at least one set of previous relative angle values comprises determining the respective current rotation direction states of the one or more rotating components or the one or more driven gears based on the previous rotation direction states of the one or more rotating components or the one or more driven gears and the relationship between their respective current absolute angle values and starting absolute angles, and includes:
if the one or more current relative angle values equal their respective previous relative angle values, determining that the one or more rotating components or the one or more driven gears are in a stationary state;
if the one or more current relative angle values exceed their respective previous relative angle values, determining, according to the definition of generalized trigonometric functions, that the one or more rotating components or the one or more driven gears are rotating toward the first quadrant or counterclockwise; and
if the one or more current relative angle values are less than their respective previous relative angle values, determining, according to the definition of generalized trigonometric functions, that the one or more rotating components or the one or more driven gears are rotating toward the fourth quadrant or clockwise.

4. The steering system angle sensing method according to claim 1, wherein the number of turns includes the number of left turns and the number of right turns, and the step of determining the number of turns of the one or more rotating components or the one or more driven gears based on the positional changes of the one or more current relative angle values and their respective at least one set of previous relative angle values relative to the plurality of preset quadrants, comprises:
recording the sequence of the one or more current relative angle values and their respective at least one set of previous relative angle values relative to the plurality of preset quadrants;
accumulating the number of turns when the one or more current relative angle values and their respective at least one set of previous relative angle values completely traverse the plurality of preset quadrants in sequence; and
resetting the number of turns and the number of right turns when the number of left turns equals the number of right turns.

5. The steering system angle sensing method according to claim 1, wherein the plurality of preset quadrants include a first quadrant, a second quadrant, a third quadrant, and a fourth quadrant, where the first quadrant ranges from 0 to 90 degrees for the one or more current angle values, the second quadrant ranges from 90 to 180 degrees for the one or more current angle values, the third quadrant ranges from 180 to 270 degrees for the one or more current angle values, and the fourth quadrant ranges from 270 to 360 degrees for the one or more current angle values.

6. The steering system angle sensing method according to claim 1, further comprising:
recording the one or more first sets of absolute angle values between 0 and 360 degrees output by the one or more magnetic angle sensors after completing the initialization procedure and their respective converted initial relative angle values, and comparing them with the one or more relative angle values converted from the one or more absolute angle values currently sensed by the one or more magnetic angle sensors to determine one or more angle offset values; and
reading the one or more initial absolute angle values stored in the storage device and the respective initial relative angle values converted from the one or more first sets of absolute angle values between 0 and 360 degrees output by the one or more magnetic angle sensors after completing the initialization procedure, and performing compensation calculations for the angle offset values, to correct the rotation angles of the one or more rotating components or the one or more driven gears.

7. The steering system angle sensing method according to claim 1, wherein the one or more rotating components are one or more driven gears.

8. The steering system angle sensing method according to claim 1, wherein the step of determining the rotation of the main gear based on the one or more relative angle values, the rotation direction of the one or more driven gears, and the number of turns of the one or more driven gears comprises:
determining the rotation ratio relationship of the one or more driven gears relative to the main gear based on the gear ratio of the main gear relative to the one or more driven gears; and
converting the one or more relative angle values, the rotation direction of the one or more driven gears, and the number of turns of the one or more driven gears into the rotation angle, rotation direction, and number of turns of the main gear based on the rotation ratio relationship.

9. The steering system angle sensing method according to claim 8, wherein the steering shaft is connected to a steering wheel.

10. The steering system angle sensing method according to claim 9, wherein the steering system angle sensing method further comprises converting the rotation of the main gear into the steering angle of the steering wheel.

11. The steering system angle sensing method according to claim 1, further comprising at least one redundant driven gear, at least one redundant magnet, and at least one redundant magnetic angle sensor, configured to replace faulty components when one or more of the one or more driven gears, the one or more magnets, and the one or more magnetic angle sensors fail.
